(19) United States
(12) Patent Application Publication
(10) Pub. No.: US 2013/0031278 A1
(43) Pub. Date: Jan. 31, 2013

(54) DATA STORAGE SYSTEM AND OPERATING METHOD THEREOF

(71) Applicant: LIANG-TSE LIN, New Taipei City (TW)

(72) Inventor: LIANG-TSE LIN, New Taipei City (TW)

(73) Assignees: San Der Saving Energy Technology LTD., New Taipei City (TW); Liang-Tse Lin, New Taipei City (TW)

(21) Appl. No.: 13/562,234

(22) Filed: Jul. 30, 2012

(30) Foreign Application Priority Data
Jul. 29, 2011 (TW) 100127097

(51) Int. Cl. G06F 3/00

(52) U.S. Cl. 710/17

(57) ABSTRACT

A data storage system includes a sensor unit, a storage unit, and a data exchange unit. The data exchange unit connects to the sensor unit and the storage unit, and transmits a data message received from the sensor unit to the storage unit, wherein the data exchange unit need not know the addresses of the sensor unit and the storage unit ahead of time to be able to successfully transmit the data message to the storage unit requesting the data message.

### BACKGROUND

1. Technical Field

The present invention generally relates to a data storage system and an operating method thereof; particularly to a data storage system and operating method thereof for central monitoring.

2. Description of the Prior Art

Sensor systems transmit information from sensors to data storages or controllers through communication methods such as serial data transmission methods. Sensor systems are fairly widely employed in central monitoring systems, although they may also be applicable in energy management, digital home systems, or other fields such as medical care. As such, data storing plays an essential role in sensor systems.

In terms of energy use and management, as human population increases, cities are gradually expanding and consuming energy at an exponential rate. As a result, energy conservation has become a determining factor for competiveness of small and large businesses alike in the marketplace. In order to conserve energy, these businesses typically place various sensors on the devices that need energy conserving so that the device may be monitored by collecting various information from the devices. The information collected from the devices may then be analyzed to provide a more efficient way to conserve energy. However, the conventional way of data collection requires massive amounts of capital and time to install the monitoring system.

FIG. 1A is an illustration of a conventional data storage system 10. As shown in FIG. 1A, the data storage system 10 includes a plurality of sensors 20, a central monitor 30, and a storage device 40. The sensors 20 of the conventional data storage system 10 typically need to be customized for each particular central monitoring system through dedicated settings or customized software. If there was a need to install a similar monitoring system in another location, a completely new system along with new sensors would need to be designed to suit that particular location. In addition, in the conventional data storage system 10, each of the plurality of sensors 20 are separately electrically connected to the central monitor 30 through connections 35 by serial communication methods. Accordingly, since the data storage device 40 is also physically connected to the central monitor 30 by serial communication methods through a connection 36, the location of the storage device 40 is restricted to being in the vicinity of the central monitor 30. In terms of large or small enterprises, as well as from the perspective of energy conservation data analyses (or energy efficiency data analyses), substantial funds would need to be prepared in order to cover the cost of tailoring a custom energy conservation monitoring system. Additionally, the central monitor 30 is serially connected to each sensor 20. Due to the fact that physical installation of the serial communication lines is considered a large project undertaking, if there is a need to expand the data storage system 10 afterwards, it would be quite hard to make changes to the amount of sensors already installed.

As shown in FIG. 1A, the central monitor 30 of the conventional data storage system 10 further includes a data storage module 32, whereas the data storage module 32 provides space to store data from a plurality of the sensors 20. When the data storage module 32 has stored a particular threshold or amount of data, the data storage module 32 transmits the stored data to the storage device 40 in order to make backups of the data. However, if there are too many sensors 20 in the data storage system 10, data originating from the plurality of the sensors 20 would be concentrated on the central monitor 30. When large amounts of data are concentrated on the central monitor 30 while the storage capacity of the data storage module 32 remains constant, the central monitor 30 will constantly and repeatedly transmit data stored in the storage module 32 to the storage device 40 for further storing. This constant repetitive storing and transmitting process increases the burden on the central monitor 30. On the other hand, in terms of analyzing data in the storage device 40 from an energy conservation perspective, since all data originating from the plurality of sensors 20 eventually are concentrated at the storage device 40, data analysts must analyze all the data in its entirety first before they may proceed with designing a new energy conservation method. In other words, users are not able to target their analysis at any one specific sensor 20 or group of sensors 20. Instead, users must analyze all the data together in order to arrive at a result. From an analyst's point of view, analyzing all the data is a time consuming process with no way of dividing up the data to allow numerous analysts to work in cooperation by each analyzing different portions of the data.

FIG. 1B is an illustration of a data storage system 50 of the conventional monitoring system that communicates through an internet network. As shown in FIG. 1 B, the data storage system 50 includes a plurality of sensors 60, a central monitor 70, and a storage device 80, wherein the central monitor 70 further includes a data storage module 72. Similar to the above mentioned data storage system 10, the central monitor 70 also concentrates and stores large amounts of data within the storage device 80. The difference here is that the central monitor 70 separately utilizes a network communication 75 and a network communication 76 to connect with the plurality of sensors 60 and the storage device 80. Since the data storage system 50 utilizes the internet to connect the sensors 60 and the storage device 80 to the central monitor 70, the actual physical location of the central monitor 70 and the storage device 80 may be varied according to design requirements. In this conventional data storage system 50, it is necessary for the central monitor 70 to have a default static internet protocol (IP) address such that the plurality of sensors 60 may locate and transmit data to the central monitor 70 on the internet. Similarly, the storage device 80 must have a default IP address such that the central monitor 70 has an IP address to transmit the data stored in the data storage module 72 to the storage device 80. In this embodiment, the central monitor 70 must first have a record of the static IP of the storage device 80 before data transmission may proceed. In terms of data analysis, there is a need to improve the convenience and efficiency of data analyses, to decrease the burden placed on the central monitor, as well as to increase the convenience of data storage of the data storage system in addition to solving the data capacity limitations of the conventional data storage system.

### SUMMARY

It is an object of the present invention to provide a data storage system with dynamic storage capacities.

It is another object of the present invention to provide a data storage system that is a open system capable of connecting a plurality of sensor units with dynamic IP addresses to a plurality of storage units with dynamic IP addresses through a data exchange unit with a static IP address such that the amount of sensor units or storage units may be dynamically increased or decreased.

It is yet another object of the present invention to provide a data storage system that utilizes a plurality of storage units to allow users to selectively transmit or assign stored data to increase the efficiency of data analyses.

It is a further object of the present invention to provide a data storage system for data analyses purposes that may be built up quickly through increasing the number of sensor units and storage units.

It is yet a further object of the present invention to provide an operating method of a data storage system that allows users to simply, succinctly, and instinctively operate thereof such that the data storage system can transmit data to a plurality of storage units in order to overcome problems of limitations in storage capacity as well as problems of concentrated data storage.

The data storage system includes at least one sensor unit, at least one storage unit, and a data exchange unit. The sensor unit generates a sensor connection signal and a data message, wherein the sensor connection signal includes a sensor identification code. The storage unit stores the data message and generates a storage connection signal, wherein the storage connection signal includes a sensor request code. The data exchange unit receives the sensor connection signal and the storage connection signal, wherein the data exchange unit transmits the data message to the storage unit when the sensor request code corresponds to the sensor identification code.

The operating method for use with the data storage system includes the following steps: generating a data message in the sensor unit, wherein the data message is provided for the storage unit to receive; generating a sensor connection signal and a storage connection signal, and enabling the data exchange unit to connect and maintain a communication connection with the sensor unit and the storage unit according to the sensor connection signal and the storage connection signal, wherein the sensor connection signal includes a sensor identification code, the storage connection signal includes a sensor request code; comparing the sensor identification code and the sensor request code, and transmitting the data message when the sensor request code corresponds to the sensor identification code; and storing the data message in the storage unit.

### BRIEF DESCRIPTION OF THE DRAWINGS

FIG. 1A is a schematic view of the conventional data storage system;

FIG. 1B is a schematic view of the conventional internet data storage system;

FIG. 2A is an embodiment of the data storage system of the present invention;

FIG. 2B-2E are embodiments of the communication methods of the data storage system of the present invention;

FIG. 3 is a one-to-many embodiment of the data storage system of the present invention;

FIG. 4 is a many-to-one embodiment of the data storage system of the present invention;

FIG. 5 is a many-to-many embodiment of the data storage system of the present invention; and

FIG. 6 is a flowchart of the operating method of the data storage system.

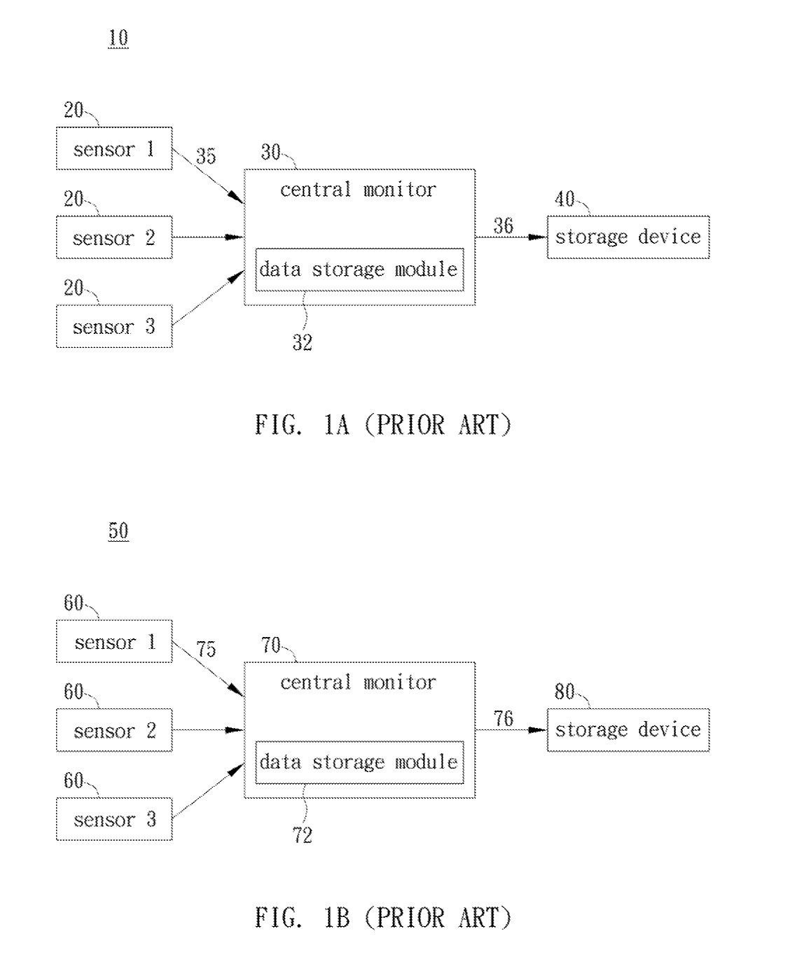

### DETAILED DESCRIPTION

The present invention provides a data storage system and operating method thereof. In a preferred embodiment, whether it concerns energy management, digital homes, medical care fields, in the office or production floor, or any other locations requiring energy conservation, users may conveniently, quickly, and simply view on-site data at these locations in order to engage in data analyses to design new energy conservation programs.

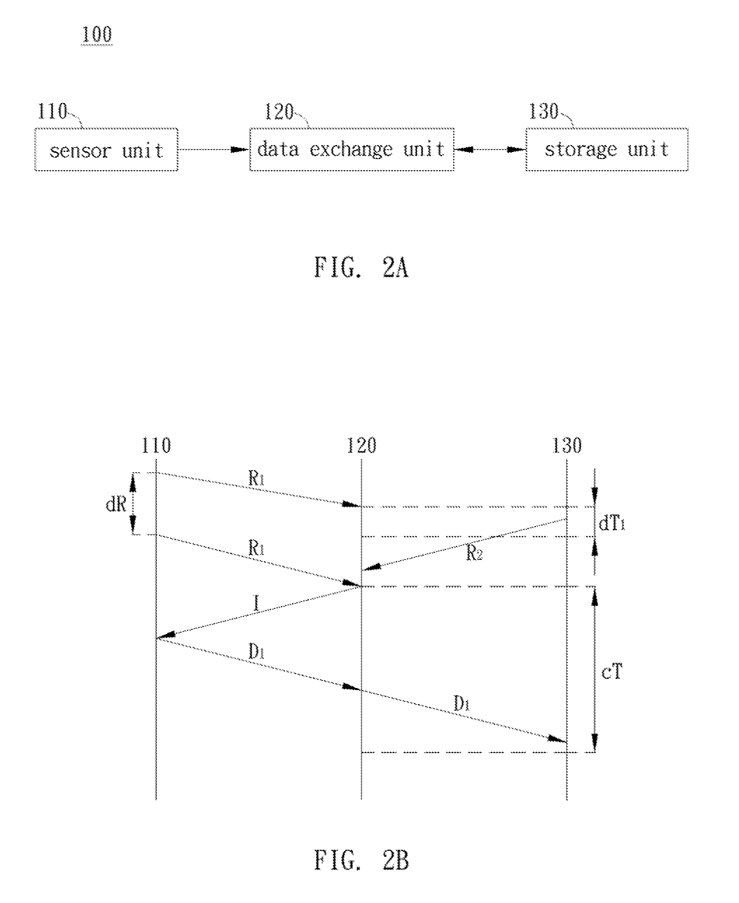

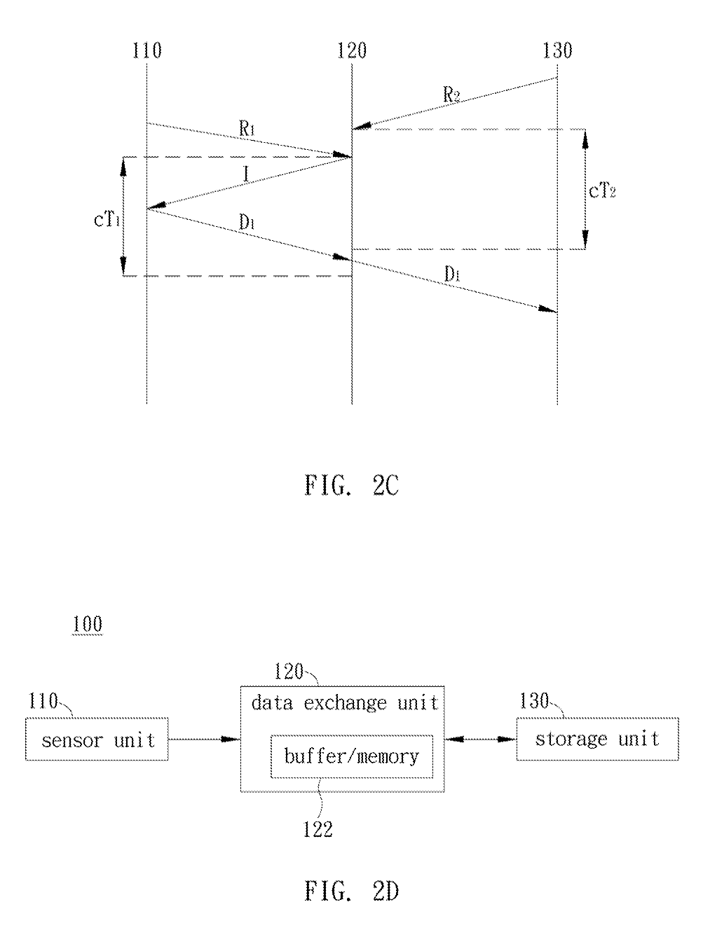

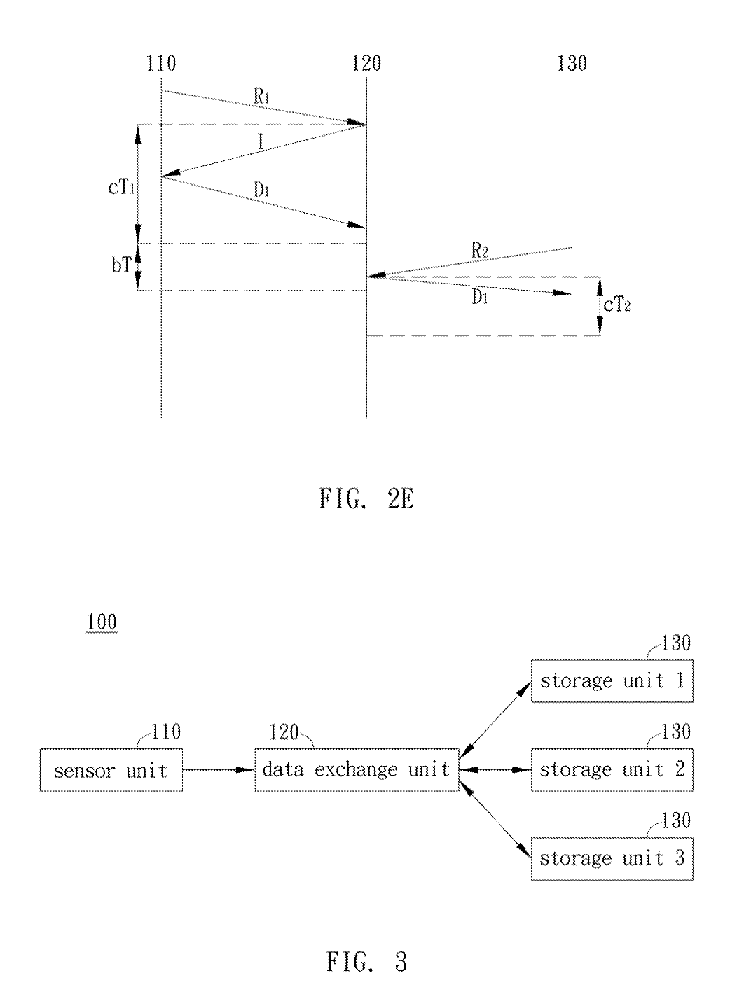

FIG. 2A illustrates an embodiment of the data storage system 100 of the present invention. At its most basic form, the data storage system 100 includes at least one sensor unit 110, at least one storage unit 130, and a data exchange unit 120. The sensor unit 110 includes temperature sensors, voltage sensors, pressure sensors, or may be any other electronic device with sensing capabilities. In more definite terms, the sensor unit 110 may be a sensor that senses and measures temperature, sound, humidity, light, electric voltage, electric current, electric resistance, frequency, acceleration, capacitance, inductance, conductance, acid-base (pH) levels, or any combination thereof. The storage unit 130 may be any storage device capable of storing data. The data exchange unit 120 is preferably a server for communicably connecting with the sensor units 110 and the storage units 130. In the present embodiment, the sensor units 110 and the storage units 130 are communicably connected to the data exchange unit 120 through the internet, wherein each sensor unit 110 and storage unit 130 have their own dynamic Internet Protocol Address (IP Address), whereas the data exchange unit 120 has a static IP Address. In the present embodiment, a characteristic of the data storage system 100 lies in that even if the dynamic IP Addresses of the sensor unit 110 or the storage unit 130 is not known or recorded in the data exchange unit 120, the data exchange unit 120 is still able to know their dynamic IP addresses by having the sensor unit 110 and storage unit 130 proactively notify the data exchange unit 120 of their dynamic IP addresses. The data exchange unit 120 is then able to provide for the sensor unit 110 and the storage unit 130 an indirect communication method.

FIG. 2B illustrates another embodiment of the communication between the sensor unit 110, the data exchange unit 120, and the storage unit 130 of FIG. 2A. As shown in FIGS. 2A and 2B, the sensor unit 110 generates a sensor connection signal R₁ and a data message D₁, wherein the sensor connection signal R₁ includes a sensor identification code (such as AAA, 1234, A1B2C, or any other combination of letters and numbers). In other different embodiments, the sensor identification code may include other languages or special characters. The storage unit 130 stores the data message D₁ and generates a storage connection signal R₂, wherein the storage connection signal R₂ includes a sensor request code. In the preferred embodiment, the data exchange unit 120 communicates with the sensor unit 110 and the storage unit 130 through the internet. However, in other different embodiments, the data exchange unit 120 may be connected to the sensor unit 110 and the storage unit 130 through any network, such as a Local Area Network (LAN) or a Wireless LAN (WLAN) network. In the present embodiment, the data exchange unit 120 has a static IP address, while the sensor unit 110 and the storage unit 130 have dynamic IP addresses, wherein the sensor unit 110 and the storage unit 130 have records of the static IP address of the data exchange unit 120. In this manner, the sensor unit 110 and the storage unit 130 may proactively seek out the data exchange unit 120 on the Internet. However, in other different embodiments, the sensor unit 110, the storage unit 130, and the data exchange unit 120 may all have static IP addresses.

As shown in FIG. 2B, the sensor unit 110 will first transmit the sensor connection signal R₁ to the data exchange unit 120 through the Internet. As mentioned above, the sensor connection signal R₁ includes a sensor identification code (ex. AAA). When the data exchange unit 120 receives the sensor connection signal R₁, the data exchange unit 120 will first check the sensor identification code of the sensor connection signal R₁ to see if at this current particular time there is a storage unit 130 communicably connected to the data exchange unit 120 having a sensor request code that corresponds to the sensor identification code. If none is found, as shown in FIG. 2B, the data exchange unit 120 will be in standby mode for a default wait time dT₁ of time period. If at the end of the default wait time dT₁ the data exchange unit 120 still has not received a sensor request code of the storage connection signal R₂ corresponding to the sensor identification code received with the sensor connection signal R₁, the data exchange unit 120 will not maintain the connection status with the sensor unit 110. Conversely, if the data exchange unit 120 receives a storage connection signal R₂ with a sensor request code that corresponds to the sensor identification code of the sensor connection signal R₁ within the default wait time dT₁, the data exchange unit 120 will maintain the connection status with the sensor unit 110 and the storage unit 130 for a time period of default connection time cT. The data exchange unit 120 will then transmit a data message D₁ received from the sensor unit 110 to the storage unit 130 such that the storage unit 130 may store the data message D₁. In a preferred embodiment, the data message D₁ may include a sensor data identification code identical to the sensor identification code of the sensor connection signal R₁. When the data exchange unit 120 is in the default connection time cT (i.e. after the data exchange unit 120 has received the sensor connection signal R₁ and the storage connection signal R₂ during the default wait time dT₁), as shown in FIG. 2B, the data exchange unit 120 will first transmit a data request signal I to the sensor unit 110. Upon receiving the data request signal I, the sensor unit 110 will transmit the data message D₁ to the data exchange unit 120. The data exchange unit 120 will then verify the sensor data identification code of the data message D₁ to see if it corresponds to the sensor request code of the storage connection signal R₂. After verifying that they correspond to each other, the data exchange unit 120 will transmit the data message D₁ to the storage unit 130. However, in other different embodiments, the data exchange unit 120 does not necessarily need to transmit the data request signal I. As shown in FIG. 2B, the sensor unit 110 may also periodically transmit the sensor connection signal R₁ to the data exchange unit 120 within a default time period dR. In this embodiment, the sensor connection signal R₁ may include the data message D₁. In other words, the sensor unit 110 will automatically, proactively, and periodically transmit the sensor connection signal R₁ and the data message D₁ to the data exchange unit 120. In this embodiment, the default time period dR is preferably smaller than the default connection time cT.

FIG. 2C illustrates another embodiment of FIG. 2A. As shown in FIGS. 2A and 2C, the data exchange unit 120 may separately decide to maintain the connection status with the sensor unit 110 or the storage unit 130 according to the sensor connection signal R₁ or the storage connection signal R₂ received by the data exchange unit 120. For instance, as shown in FIG. 2C, when the data exchange unit 120 receives the storage connection signal R₂ from the storage unit 130, the data exchange unit 120 will maintain the communication connection status with the storage unit 130 for a second default connection time cT₂. Conversely, when the data exchange unit 120 receives the sensor connection signal R₁ from the sensor unit 110, the data exchange unit 120 will maintain the communication connection status with the sensor unit 110 for a first default connection time cT₁. As shown in FIG. 2C, if the data exchange unit 120 is already maintain the connection status with the storage unit 130 when it receives the sensor connection signal R₁ from the sensor unit 110, the data exchange unit 120 will first verify whether or not the sensor identification code of the sensor connection signal R₁ corresponds to the sensor request code of the storage connection signal R₂. If they correspond, the data exchange unit 120 will then transmit the data request signal I to the sensor unit 110. When the sensor unit 110 receives the data request signal I, the sensor unit 110 will transmit the data message D₁ to the data exchange unit 120, and after the data exchange unit 120 verifies the sensor identification code, the data message D₁ will then be transmitted to the storage unit 130 by the data exchange unit 120. However, in other different embodiments, the sensor connection signal R₁ may also include the data message D₁. As shown in FIG. 2C, when the data exchange unit 120 receives the sensor connection signal R₁ from the sensor unit 110 while the data exchange unit 120 is maintaining the communication connection status with the storage unit 130, since the sensor connection signal R₁ includes the data message D₁, the data exchange unit 120 will verify the sensor identification code and then directly transmit the data message D₁ to the storage unit 130.

FIG. 2D is another embodiment of FIG. 2A. As shown in FIG. 2D, the data exchange unit 120 further includes a buffer/memory 122 to provide the data exchange unit 120 with a temporary data storage space. Through the use of the buffer/memory 122, the overall energy consumption of the data storage system 100 may be decreased by adjusting the first default connection time cT₁ and the second default connection time cT₂ such that the connection time between the data exchange unit 120 with the sensor unit 110 and the storage unit 130 may be reduced.

FIG. 2E illustrates a communication method of the sensor unit 110, the data exchange unit 120, and the storage unit 130 of FIG. 2D. As shown in FIGS. 2D and 2E, when the data exchange unit 120 receives the sensor connection signal R₁, the data exchange unit 120 will maintain a connection status with the sensor unit 110 for a time period of the first default connection time cT₁. Within this default connection time cT₁, the data exchange unit 120 will receive from the sensor unit 110 the data message D₁. As shown in FIG. 2E, if the data exchange unit 120 still has not received a storage connection signal R₂ from the storage unit 130 at the end of the first default connection time cT₁, the data exchange unit 120 will temporarily store the data message D₁ in the buffer/memory 122. The storage time in the buffer/memory 122 is defined by a default buffer time bT. If the data exchange unit 120 receives a storage connection signal R₂ having a sensor request code corresponding to the sensor connection signal R₁ of the data message D₁ stored in the buffer/memory 122 before the end of the default buffer time bT, the data exchange unit 120 will transmit the data message D₁ stored in the buffer/memory 122 to the storage unit 130.

The embodiments mentioned above have all dealt with one-to-one (a single sensor unit 110 corresponding to a single storage unit 130) forms of the present invention. The following will describe other embodiments of the data storage system 100 of the present invention. It should be noted that the following embodiments may be applied in conjunction with the above embodiments, or may be applied by themselves as will be described in detail below.

FIG. 3 illustrates a one-to-many embodiment of the data storage system 100 of the present invention. One-to-many refers to a single sensor unit 110 corresponding to a plurality of storage units 130. As shown in FIG. 3, the data storage system 100 includes one sensor unit 110 that is communicably connected to a plurality of storage units 130 through the data exchange unit 120 over the Internet. In the present embodiment, as an example, if the sensor identification code of the sensor unit 110 is “AAA”, the plurality of storage units 130 (storage units 1 to 3) may designate the sensor request code be “AAA”, such that the storage unit(s) 130 may transmit the sensor request code through the storage connection signal R₂ to the data exchange unit 120 to request the data message D₁ of the sensor unit 110 having the sensor identification code “AAA” from the data exchange unit 120. In other words, the data message D₁ from the sensor unit 110 may be transmitted at the same time to a plurality of storage units 130. From the perspective of the users, this transmission method enables multiple users to receive the same data message D₁. Since the data exchange unit 120 is communicably connected to the plurality of storage units 130 through the Internet, the actual location of each user is not limited to being in the vicinity of the data exchange unit 120. The advantage of this is that the data storage system 100 may provide multiple different users with the same data for data analyzing purposes. At the same time, storing the data message D₁ in a plurality of storage units 130 is akin to backing up the data message D₁ multiple times (backup redundancy) such that the rate of data loss due to accidental erasing of the data may be decreased. For instance, if the data storage system 100 is applied to an energy conservation monitoring system where the data message D₁ of the sensor unit 110 is relatively large in size, a plurality of energy conservation data analysts (users) may receive the same data of the data message D₁ through the one-to-many function of the data storage system 100 of the present invention. In this manner, many energy conservation data analysts may analyze the data message D₁ concurrently. If the number of analysts needs to be increased to analyze the data message D₁, the data storage system 100 would only need to increase the number of storage units 130 to accomplish this task. The newly added storage units 130 would only need to be set up to have sensor request codes corresponding to the sensor identification code of the sensor unit 110 before receiving the data message D₁ from the sensor unit 110.

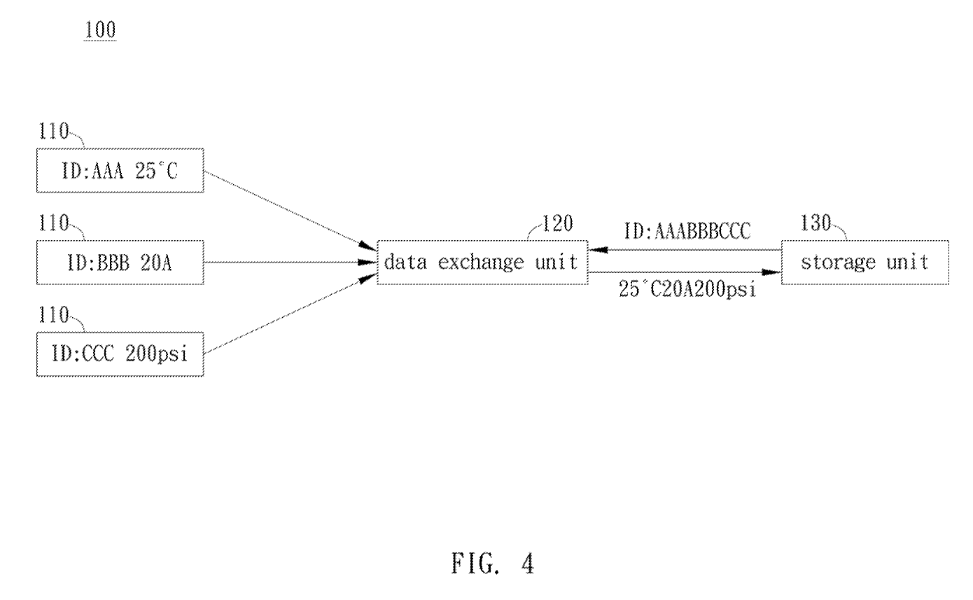

FIG. 4 illustrates a many-to-one embodiment of the data storage system 100. As shown in FIG. 4, the data storage system 100 includes a plurality of sensor units 110. The plurality of sensor units 110 may provide similar or different sensor data. As an example, the first sensor unit 110 may have a sensor identification code of “AAA” and a data message of 25C. The second sensor unit 110 may have a sensor identification code of “BBB” with a data message of 20A. The third sensor unit 110 may have a sensor identification code of “CCC” with a data message of 200 psi. In the present embodiment, the sensor request code of the storage unit 130 may designate more than one sensor unit 130. For example, as shown in FIG. 4, the sensor request code of the storage unit 130 may be “AAABBBCCC” (in other words, requesting the data messages from the sensor units with sensor identification codes of “AAA”, “BBB”, and “CCC”). When the data exchange unit 120 receives the senor request code from the storage unit 130, the data exchange unit 120 will separately communicably be in connection with the sensor units 130 corresponding to the sensor identification codes “AAA”, “BBB”, and “CCC”. The data exchange unit 120 will then receive from these sensor units 110 their data messages (as shown in FIG. 4, the data messages are: 25C, 20A, and 200 psi). The data exchange unit 120 will then combine these messages into an aggregate data message and then transmit it to the storage unit 130. In other words, as shown in FIG. 4, if the sensor request code of the storage unit 130 is “AAABBBCCC”, the data exchange unit 120 will combine/aggregate the data messages from the sensor units 110 corresponding to AAA, BBB, and CCC as “25C 20A 200 psi”, and will then transmit this aggregate data message to the storage unit 130. If the data storage system 100 is applied to an energy conservation monitoring system, users (energy conservation data analysts) may selectively request the data messages D₁ from a subset of the sensor units 110 from the plurality of sensor units 110. The advantage to this is that users may narrow the scope of the data that needs to be analyzed. At the same time, different data may be transmitted to the same user at the same time for data analysis. This in turn allows users to reduce the overall time needed to analyze data instead of analyzing data from the entire system.

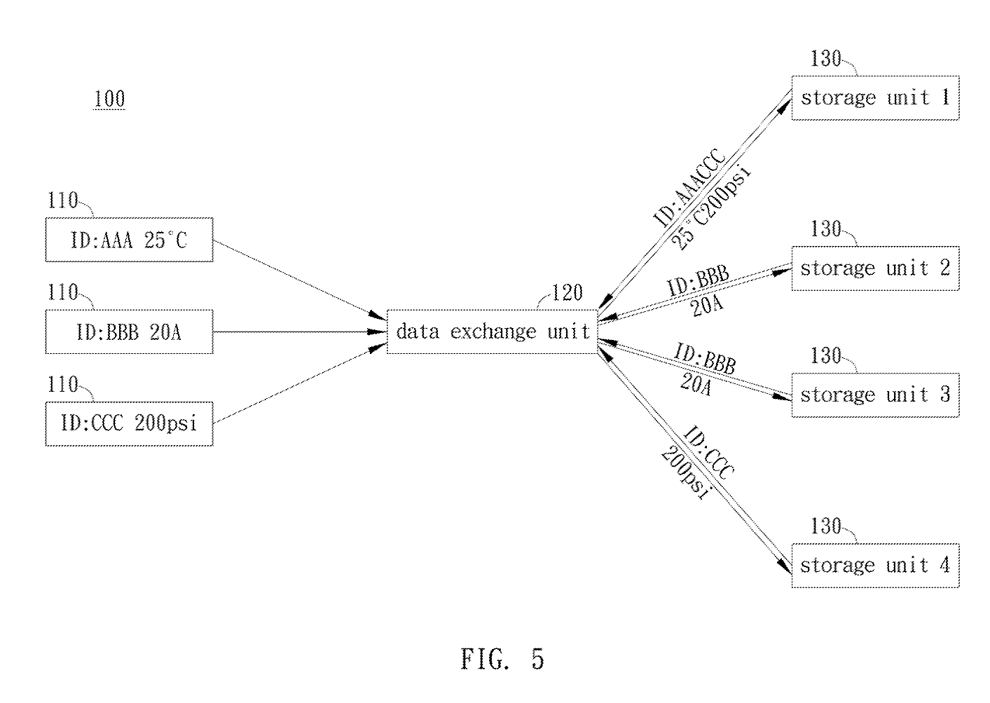

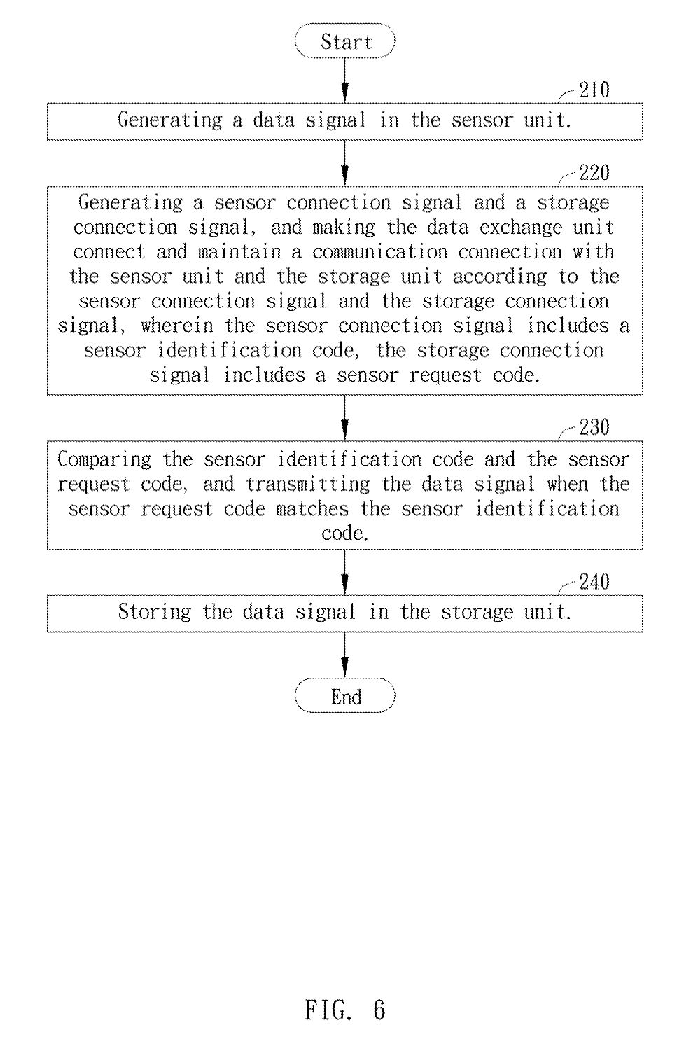

FIG. 5 illustrates a many-to-many embodiment of the data storage system 100. The present embodiment has the combined functions of the embodiments mentioned in FIGS. 2A, 2D, 3, and 4. As shown in FIG. 5, the data storage system 100 may transmits the data message D₁ from a single sensor unit 110 through the data exchange unit 120 to a plurality of storage units 130. The data storage system 100 may also transmit the data messages D₁ from many sensor units 110 to one storage unit 130. The data storage system 100 can also transmit data message D₁, according to the sensor identification code and the sensor request code, in any of the transmission formats of one-to-one, one-to-many, many-to-one, or many-to-many transmission methods. In terms of FIG. 5, the storage units 2 and 3 form a one-to-many relationship with the sensor unit BBB. The storage unit 1 forms a many-to-one relationship with the sensor units BBB and CCC. The sensor units AAA, BBB, and CCC form a many-to-many relationship with storage units 1 to 4. The advantage of the present embodiment is that each storage unit 130 may target their communication with only a portion of the data storage system 100, whereby conserving energy in the process.

FIG. 6 is an embodiment of the flowchart of the operating method of the data storage system of the present invention. As shown in FIG. 6, the operating method includes the following steps.

Step 210 includes generating a data message in the sensor unit, wherein the data message is provided for the storage unit to receive. In the preferred embodiment, the data message is transmitted to the storage unit through a data exchange unit over the Internet. The sensor unit may be a sensor that senses temperature, sound, humidity, light, electric voltage, electric current, electric resistance, frequency, acceleration, capacitance, inductance, conductance, acid-base levels, or a combination thereof. The data message may be any electric message or signal generated from the above.

Step 220 includes generating a sensor connection signal and a storage connection signal, and enabling the data exchange unit to connect and maintain a communication connection with the sensor unit and the storage unit according to the sensor connection signal and the storage connection signal, wherein the sensor connection signal includes a sensor identification code and the storage connection signal includes a sensor request code. In more definite terms, the sensor connection signal is generated in the sensor unit and transmitted to the data exchange unit through the Internet, wherein its purpose is to notify the data exchange unit of the IP address of the sensor unit. The sensor connection signal is also used to request of the data exchange unit to maintain a communication connection with the sensor unit such that the sensor unit may be in contact with the data exchange unit without having to notify the data exchange unit of the sensor unit's IP address again. In a similar manner, the storage connection signal is generated in the storage unit and has a similar function to the above mentioned sensor connection signal. The sensor identification code and the sensor request code may be letters, numbers, or a combination thereof.

Step 230 includes comparing the sensor identification code and the sensor request code, and then transmitting the data signal when the sensor request code corresponds to the sensor identification code. In more definite terms, the data exchange unit will compare the sensor request code with the sensor identification code and then determine whether or not the two are identical. If the data exchange unit determines that they are identical, the data exchange unit will transmit the data message from the sensor unit corresponding to the sensor request code to the storage unit. However, in other different embodiments, step 230 may further include aggregating the data messages from a plurality of the sensor units into an aggregate data message, and then transmit it to the storage unit.

Step 240 includes storing the data message in the storage unit. In the present embodiment, the storage unit may include any data storage device capable of storing electronic signals or messages.

Accordingly from the above, the data storage system 100 of the present invention has the following advantages:

Firstly, since the data storage system 100 is communicably connected through the Internet, the physical location of the sensor unit(s) 110, the data exchange unit 120, and the storage unit(s) 130 may in actuality be completely different places. The sensor unit 110 and the storage unit 130 need only be connected to the Internet through an Ethernet cable or through wireless methods to connect with the data storage system 100. The advantage here is that the sensor units 110 do not need to be restricted to being disposed in the vicinity of the data exchange unit 120 nor in the vicinity of the storage unit 130. The storage unit 130 also doesn't need to be disposed in the vicinity of the sensor unit 110 nor the data exchange unit 120.

The second advantage lies in that the sensor units 110 and the storage units 130 have records of the static IP address of the data exchange unit 120. Even in the circumstance that the sensor unit 110 or the storage unit 130 is placed behind a firewall, the sensor unit 110 and the storage unit 130 are still able to simply and quickly connect with the data exchange unit 120 such that users do not need to worry or frustrate about setting up dedicated communication bypasses for the sensor unit 110 and the storage unit 130 in the firewall so that the sensor unit 110 or the storage unit 130 behind the firewall may communicate with the data exchange unit 120. Simply stated, the sensor unit 110 and the storage unit 130 only need to be plugged into the internet through an Ethernet line or through wireless means to simply and quickly connect with the data exchange unit 120 to form the data storage system 100.

The third advantage to the present invention is that since the data exchange unit 120 does not have a record of the IP addresses of the individual sensor units 110 and storage units 130 ahead of time, but rather instead relies on the sensor units 110 and the storage units 130 to have a record of the data exchange unit 120's static IP address, the structure of the data storage system 100 may be changed at any time without having to worry or frustrate over resetting the settings of each sensor unit 110 and storage unit 130 in relation to the data exchange unit 120. If users need to change the structure of the data storage system 100, they only need to increase, decrease, and/or move the sensor units 110 or data storage units 130. As an example, if an user A has already built up a data storage system 100, and if another user B wanted to access information from the data storage system 100 under different conditions, user B would only need to add one or more storage units 130 to the data storage system 100 and then set the new storage unit(s) 130 to retrieve the data from the specific sensor units 110 that user B wants. In this manner, the entire data storage system 100 does not need to be overhauled in order to change the parameters of how a user would like to retrieve data from the sensor units 110.

The fourth advantage to the present invention is that since the data exchange unit 120 does not need to record the IP addresses of the sensor units 110 and storage units 130 long term, and doesn't need to hold onto data received from the sensor units 110 for too long, the burden placed on the data exchange unit 120 is decreased dramatically. As such, the data storage rate, transfer speed, and efficiency of the data storage system 100 may be increased. As well, increasing the number of sensor units 110 or/and storage units 130 will not adversely affect the performance of the data exchange unit 120.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A data storage system, comprising:
at least one sensor unit for generating a sensor connection signal and a data message, wherein the sensor connection signal includes a sensor identification code;
at least one storage unit for storing the data message and generating a storage connection signal, wherein the storage connection signal includes a sensor request code; and
a data exchange unit for receiving the sensor connection signal and the storage connection signal, wherein the data exchange unit transmits the data message to the storage unit when the sensor request code corresponds to the sensor identification code.

2. The data storage system of claim 1, wherein the sensor connection signal further includes a sensor address signal, the storage unit connection signal further includes a storage unit address signal, the data exchange unit maintains a connection status with the sensor unit and the storage unit according to the sensor address signal and the storage unit address signal.

3. The data storage system of claim 2, wherein the data exchange unit maintains the connection status with the sensor unit within a first default connection time and maintains the connection status with the storage unit within a second default connection time.

4. The data storage system of claim 1, wherein the data exchange unit is communicably connected to the sensor unit and the storage unit by internet communication or serial communication.

5. The data storage system of claim 1, wherein the sensor unit is a sensor that senses temperature, sound, humidity, light, electric voltage, electric current, electric resistance, frequency, acceleration, capacitance, inductance, conductance, acidity-base levels, or a combination thereof.

6. The data storage system of claim 1, wherein the data exchange unit combines the data messages from a plurality of the sensor units into an aggregate data message.

7. The data storage system of claim 1, wherein the at least one storage unit is a data storage device capable of storing electronic signals.

8. The data storage system of claim 7, wherein the electronic signals include digital encoding of continuous electric voltage or current signals.

9. An operating method of a data storage system, wherein the data storage system comprises at least one sensor unit, at least one storage unit, and a data exchange unit, the operating method comprises:
generating a data message in the sensor unit, wherein the data message is provided for the storage unit to receive;
generating a sensor connection signal and a storage connection signal, and making the data exchange unit to connect and maintain a communication connection with the sensor unit and the storage unit according to the sensor connection signal and the storage connection signal, wherein the sensor connection signal comprises a sensor identification code, the storage connection signal comprises a sensor request code;
comparing the sensor identification code and the sensor request code, and transmitting the data message when the sensor request code corresponds to the sensor identification code; and
storing the data message in the storage unit.

10. The operating method of claim 9, wherein the sensor connection signal further includes a sensor address signal, and the storage connection signal includes a storage address signal, the data exchange unit maintains the communication connection status with the sensor unit and the storage unit according to the sensor address signal and the storage address signal.

11. The operating method of claim 9, wherein the data message of the sensor unit is derived from measuring data of the electronic signal or the memory area.

12. The operating method of claim 9, wherein the data exchange unit maintains the connection status with the sensor unit for a first default connection time, the data exchange unit maintains the connection status with the storage unit for a second default connection time.

13. The operating method of claim 9, further comprising combining data messages from a plurality of the sensor units into an aggregate data message.

14. The operating method of claim 9, wherein the communication connection between the data exchange unit with the sensor unit and the storage unit is an internet or serial communication method.
